(19) United States
(12) Patent Application Publication
(10) Pub. No.: US 2004/0131510 A1
(43) Pub. Date: Jul. 8, 2004

(54) Synthesis device and method for producing the same

(76) Inventors: Harald Rau, Dossenheim (DE); Michael Frank, Heidelberg (DE); Kristina Schmidt, Heidelberg (DE); Stefan Dickopf, Heidelberg (DE); Klaus Burkert, Heidelberg (DE)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/468,967

(22) PCT Filed: Feb. 6, 2002
(86) PCT No.: PCT/EP02/01217

(30) Foreign Application Priority Data
Feb. 23, 2001 (DE) 101 08 892.2

(51) Int. Cl. B01J 19/00

(52) U.S. Cl. 422/130

(57) ABSTRACT

The present invention relates to a synthesis apparatus, especially for use in combinatorial chemistry (e.g., solid phase synthesis) as well as a method of manufacturing the same. The synthesis apparatus according to the present invention comprises essentially a vessel, e.g., a microtiterplate, with wall and/or bottom sections as well as a solid phase support, e.g., membranes, which are suitable for use in solid phase synthesis. By thermal effects in an area, preferably a very limited area, of the solid phase support the support is fixed to at least one section of the vessel.

The present invention relates to a synthesis apparatus, especially for the use incombinatorial chemistry (e.g., solid phase synthesis) as well as to a method of manufacturing the same.

For the production of a multitude of chemicals compounds various methods and apparatuses have been developed in the past, which minimize the time for the synthesis of this multitude of chemical compounds and if possible simultaneously automatize all procedures and miniaturize the sizes of the apparatuses. Here paralleling of the synthesis procedures for the various chemical products plays an important role, i.a., all syntheses should work according to one synthesis protocol.

It has become obvious that syntheses on solid phase are especially well suited to fulfill the above-mentioned requirements. First developments in the field of solid phase synthesis have been made by Merrifield et all (R. B. Merrifield, J. Am. Chem. Soc. 85, 2149-2154 (1963)).

A synthesis concept used for the generation of a multitude of chemical compounds is the so-called combinatorial chemistry. Which embraces a whole range of techniques which are able to produce in a few, often automatized reaction series a multitude of different compounds (so-called compound depositories) (see, e.g., M. A: Gallop et al, J. Med. Chem. 37 (1994), 1233-1251; E. M. Gorden et al, J. Med. Chem. 37 (1994), 1385-1401). Here, too, the reactions are preferably conducted on solid phase for practical reasons. The support materials are usually transversally interlaced polymers in particle form (so-called beads of polystyrol, or polyethyleneglycol/polystyrene resin). Starting from a functionalized surface, the desired structures are made-up in multiple synthesis steps. An overview over the synthesis of compound depositories on solid phase as well as in solutions is given by L. A. Thompson and J. A. Ellman, Chem. Rev. 96 (1996), 555-600. After finishing a combinatorial solid phase synthesis the products are separated in general from the solid phase, i.e., by separating an instable bonding between the final product and the support resin. Here often linkers are used, which function as a bonding member between the support resin and the desired chemical compound. (With regard to solid phase support, linker and suitable reactions, see, e.g., Florenzio Zaragoza Dörwald, Organic Synthesis on Solid Phase, Supports, Linkers, Reactions, Wiley-VCH, Weinheim 2000).

Besides the already mentioned beads planar supports also have an important role in the solid phase synthesis. Here, the most important materials are glass, membranes of cellulose and other polymer materials. For synthesis purposes, the materials should be porous, mechanically and chemically stable but also easy to be separated, in order to achieve an as high as possible synthesis capacity per (surface) area unit and to guarantee universal handling. These requirements are only fulfilled by membranes of natural (like cellulose) and synthetic origin. The latter are made, e.g., of polyethylene superimposed by polystyrene which in turn is functionalized by aminomethylising, or of polypropylene, which is encoated with cross-linked polyhydroxypropylacrylat (Michal Lebl, Biopolymers (Peptide Science) 47, 397-404 (1998)). Also, the use of transversally interlaced functionalized Teflon® membranes for the synthesis of combinatorial depositories is known (M. Stankov{acute over (a+EE, S. Wade, K. S. Lam, M. Lebl, Peptide Research 7, 292-298 (1994)). Further polymer compounds of membranes for the synthesis of oligopeptides and nucleotides are described in U.S. Pat. No. 4,923,901. )}

Besides the support used for the solid phase synthesis the choice of the geometry of the synthesis reactor also plays an important role for the automatizing and miniaturizing. Here the synthesis areas should be generally arranged in a uniform grid and should be position-addressable. Usually vessels are used in which the solid phase material (beads, membrane pieces etc.) are introduced, the vessels being firmly bonded to each other by casting. In order to facilitate the use of effective robots for pipetting or the like, the vessels should be open on the upper face. e.g., a microtiterplate complies with these requirements. If membranes are used also a whole membrane sheet can be looked upon as a planar synthesis reactor.

In the latter case especially the spot synthesis is appliable, which is also applied in the case of cellulose (Michal Lebl, Biopolymers (Peptide Science) 47, 397-404 (1998). In the spotting technique, the test material is transferred from a microtiterplate onto the support by means of transfer pins or multiple pipetters. Here the transfer pins are immersed in the test fluid—the drop of test fluid adhering to the point of the transfer pin is then deposited on the support. By varying the size of the pin, varying volumes of test fluid can be transferred. Sham et al. describe the spot synthesis of a combinatorial 1,3,5-triazine compound depository on various functionalized polypropylene membranes (D. Scharn, H. Wenschuh, U. Reineke, J. Schneider-Mergener, L. Germeroth, J.Comb. Chem. 2, 361-369 (2000)).

A disadvantage of the spotting technique is that during depositing the fluid a concentration gradient can from around the spot. Furthermore, sequential adding of multiple reagents for one reaction step is not possible, if these are to form a homogeneous reaction mixture. Also, an individual (spotlike) treatment of the single reaction spots (membrane areas) is not possible or only very difficult by means of batch reagents like washing solutions.

If reaction vessels are used, e.g., microtiterplates, it is advantageous if the support material is fixed in the reaction vessel. This prevents an uncontrolled floating in the reagent solution. Fixing guarantees that the support is entirely soaked and that thus there is about the same reagent concentration throughout. Even during working under reduced pressure and by using so-called plate washers fixation is advantageous. Here membrane pieces are usually to be preferred over beads, since based on the absolute capacity of synthesis a membrane unit is equivalent to a multitude of bead units, i.e., a great deal of beads are necessary to achieve a synthesis capacity comparable to that of a piece of membrane in the size of the bottom of a microtiterplate cavity. The handling of such beads is difficult and especially its fixing is very awkward.

WO-A-94/05394 describes various possibilities of the fixing of solid phase supports. On the one hand a multi-layered support (three plates) is suggested in which a reaction vessel forms by corresponding apertures in the topmost layers. In the bottom area beads are fixed by a suitable adhesive. This is very inconvenient, since—as already mentioned—the handling of very small particles is necessary. Furthermore the synthesis conditions and the reagents used have to be adjusted to the adhesive used. Also it cannot be ruled out that the adhesive negatively influences synthesis properties of the beads.

An alternative described in WO-A-94/05394 suggests the superimposing of a polymerfilm in the bottom area of the multi-layered reaction vessel. Here the bottom plate of polyethylene is provided in multiple steps with acid chloride functionalities, in order for, e.g., a methacrylamide polymer to be applied on which in its turn a polyacryalmide gel is superimposed which is transversally interlaced with bisacrylamide and has additionally to be functionalized, in order for e.g., a suitable linker or spacer to be chemically bonded for solid phase synthesis. Such a construction of a polymer film suitable for the solid phase synthesis thus embraces several chemical steps and is thus quite demanding. Furthermore during the construction of the multi-layered reaction vessel attention has to be paid to a sufficient tightness in the intermediate area between the individual plates.

A further possibility which is described in WO-A-94/05394 starts from the use of a substrate in form of a sintered polyethylene disc with a diameter of ¼″ and a thickness of ⅛″. This is coated with a thin, hydrophilic, polar, multi-functionalized polymer film (HPMP) and is pressed into the recess of a plate so that the whole reaction space is filled. Pressing the film into the recess is to prevent it from falling out while a taper in the bottom area preventing it from slipping out downwardly. Furthermore one or more channels are provided in order to produce a vacuum and thus a fluid transport is facilitated. The size of the disc is an obstacle to the miniaturization of the apparatus, as well as fluid transport by suction is difficult on the apparatus side and can also be miniaturized only with great efforts.

U.S. Pat. No. 6,063,338 discloses a microtiterplate, which contains a cycloolefin for spectroscopic purposes and is also said to be suitable for solid phase synthesis. This document suggests, i.a., that the inner walls and bottoms of the cavities should be functionalized in order to immobilize components for solid phase synthesis. Disadvantageous of such an approach is the low synthesis capacity, which is only achieved by surface treatment.

WO-A-99/32219 describes a solid phase system working in parallel, in which whole membranes are pressed in between plates with apertures laying over each other and having cylindrical nozzles on the top and bottom side, in order to achieve a pump system running from the top side to the bottom side. Furthermore, beads are suggested for solid phase supports, which are introduced into vessels, formed by the recesses of a plate with an incorporated fritted bottom. Pumping the fluid at least guarantees that a certain fixing in the bottom area is possible, i.e., a continuous floating of the particles is prevented. But such a pump system is very demanding and miniaturization is only very difficult to be achieved. Especially if membrane sheets are used attention has to be paid that a sealing of one flow channel against the adjacent one is achieved. Also the use of valves is suggested which cause an additional effort on the apparatus side.

EP-A-0 608 779 discloses an apparatus for the peptide synthesis, providing a microtitierplate in which membrane pieces are clamped in the individual cavities and are thus fixed. Clamping is achieved in that the diameter of the pieces is chosen so that it is somewhat greater than the diameter of the cavities. Here it is especially disadvantageous that in the margin area between the membrane and the microtiterplate bottom hollow spaces form which are an obstacle to an unhindered fluid exchange. Furthermore, it cannot be prevented that the pieces are set free from the cavities during certain procedures, e.g., during vacuum drying. Also, for such a fixation a certain thickness of the membrane is necessary since otherwise if small and thin membrane pieces are used, as are, e.g., necessary in a 96 microtiterplate, the edges of the membrane pieces can roll up on contact with the fluid and thus the fixing effect is removed.

The object of the present invention is to provide an improved synthesis apparatus or device, in which a solid phase support is fixed in the reaction vessel as well as a method of manufacturing the same. This object is attained by the features of the independent claims. Preferred embodiments are described in the dependent claims.

The invention starts from the basic idea to equip the synthesis apparatus essentially with a vessel with wall and/or bottom areas as well as a solid phase support for the use in the solid phase synthesis whereby preferably by thermal effects on a relatively limited area of the solid phase support a fixing of the support at at least one of the vessel areas is achieved.

According to a preferred embodiment of the present invention; chemically functionalized membranes having a polymer are used as solid phase support. Preferably a multitude of vessels are arranged in an uniform grid and are bonded with each other by casting or an integral housing. This arrangement is advantageously of plastic, especially preferred is a microtiterplate. The bonding between membrane and inner surface of a vessel is preferably achieved by a spot welding method, i.e., both materials should ideally have thermoplastic properties and should form a stable bonding with each other by a melting process. However, e.g. in the case of teflon membranes and cellulose, it is surprisingly sufficient if only the plastic vessel has thermoplastic properties. The pasting or welding (fixing) is amazingly stable both against mechanical or chemical impacts, so that normally removal is only possible if the membrane is destroyed. Furthermore the plastics used should be stable against the chemicals and solvents used for the chemical synthesis. Furthermore, a certain thermal stability is advantageous.

Polypropylene has shown to be an especially well suited material for plastic vessels. Polypropylene is inert against almost all organic solvents and also stable against aggressive reagents. The usable thermal range is usually between about −80° C. and 100° C. As vessels, various in size standardized polypropylene microtiterplates (PP-MTP) are available. These can be obtained with a different number of cavities and volumes on a large scale. At the moment polypropylene MTPs are available with 24, 96, 384 or 1536 cavities and volumes from 8 μl to 2.7 ml and a bottom area from 1.56 mm² to 700 mm² per cavity. Various porous, absorbent polypropylene and teflon membranes i.a. have proved to be suitableas reactive phase. Polypropylene membranes with various loading densities of reactive functionality (80-2500 nmol/cm²) are purchasable. These membranes are available with hydroxyl- and amino groups as functional groups.

In the following preferred embodiments of the present invention are described with respect to the drawings in more detail:

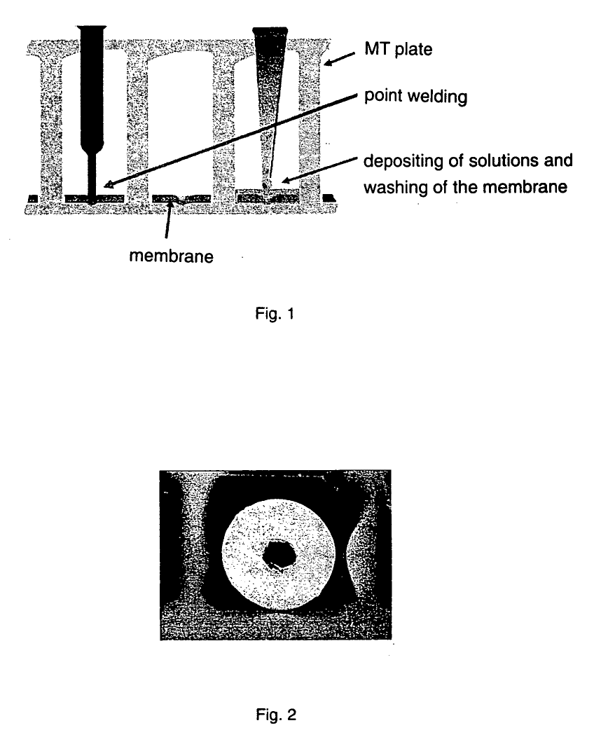

FIG. 1 shows a schematic cross-sectional view of the synthesis apparatus according to the present invention;

FIG. 2 shows the loss of synthesis amount of a fixed membrane in comparison to a non-fixed membrane by means of the ratio of the vitrified area to the total area; and

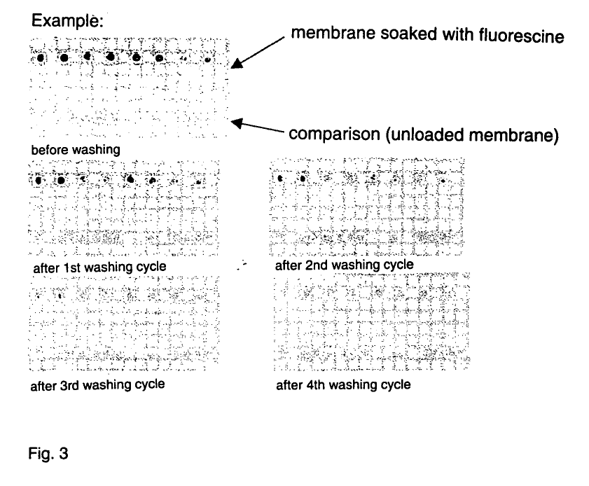

FIG. 3 shows a 384 microtiterplate during various cycles in the removal of reagent remainders.

In the embodiment according to the present invention shown in FIG. 1 the membrane is fixed in the bottom area of the vessel. However the membrane could also or additionally be fixed to the wall areas of the vessel or cavities. The geometry of the membrane piece can advantageously adapted to the cavity, especially to the bottom of the cavity in such a manner that the forms are essentially the same (e.g., round membrane pieces for round cavities) and the walls are hardly or not at all in contact with the membrane.

A preferred embodiment of the manufacturing method according to the present invention of the described synthesis vessels starts with the stamping of the membrane into the microtiterplates (MTP). Here, e.g., a stamping machine can be used wherein the MTP is located below the stamping blade(s). Such stamping machines are described, e.g., in U.S. Pat. No. 5,146,794. During stamping the membrane cutouts (or membrane pieces) fall preferably directly into the cavities of the MTP.

The membrane cutouts are dimensioned in a manner that they do not tilt in the cavities but that they are slightly smaller than the internal size of the cavities.

It has proved useful, to spray the MTPs to be provided with membrane pieces with a suitable fluid, e.g., ethanol, since otherwise the membrane pieces—assumably due to static charging—partially adhere to the walls of the cavities instead of the bottom.

For fixing the membranes to the MTP a thermal method is surprisingly particularly advantageous. Here preferably a metal point (e.g., electrically) heated to 450° C. and having a diameter of about 0.3 mm is pressed for 0.8 s onto the membrane which is on the bottom of a cavity of the MTP. This procedure can be automatized with common robots. During welding a punctual melting of the membrane (in case of a polypropylene membrane) and the underlying MTP material (e.g., PP-MTP) occurs. During the following hardening a stable bonding between the two components forms.

It has been shown that the membrane looses its porosity in a relative small area around the welding point due to the thermal melting of the material. The area of thermoplastic deformation where a considerable synthesis yield can no longer be expected is about 0.7 mm around the center of the melting or welding point. The percentual yield loss is, however, surprisingly negligibly small in comparison to a non-fixed membrane cutout of the same size. It is generally dependent from the size of the membrane piece und the MTPused. For a commercial 1536 MTP, the geometrically determined loss is preferably less than 5%.

The thus manufactured multi-synthesis plates can be cleaned with suitable organic solvents and then be dried prior to their use. During the cleansing step thermal decomposition products formed during melting are removed.

Due to the use of a synthesis apparatus with solid phase support according to the present invention, it is possible to use usual pipetting robots, dispensing automats and plate washer as well as vacuum drying. Furthermore multiple addition and the suction of reagent solutions is possible. Due to the point welding, the membrane pieces are very well washed by wash and other solutions and no reservoir forms between the solid phase support and bottom area. Furthermore the apparatus according to the present invention is very variable with respect to the desired synthesis amount by using various MTPs or membranes. The synthesis mass can very well be adjusted by the area of the membrane. Due to vitrifying the contact point in the welding of the membrane, visual control of the welding quality, advantageously on the back side of a MTP, is possible. A further advantage is that the membrane can be functionalized batchwise before stamping.

A preferred use of the synthesis apparatus according to the present invention is in the field of the combinatorial chemistry, as a multitude of various compounds can be obtained in a very short period of time and with comparatively simple means due to parallelizing and miniaturizing.

### EXAMPLES

### Example 1

### Loss of Synthesis Amount of a Fixed Membrane in Comparison with a Non-Fixed Membrane

a) The geometrical loss (ratio of the vitrified area to the total area according to FIG. 2 by fixing by an metal needle) was determined for a 384 PP-MTP and a with an amino-group functionalized membrane from the manufacturer AIMS Scientific Products GbR, Braunschweig (800 nmol/cm²) to be less than 5%.

b) The loss of chemical yield under the same conditions as in a) was determined by coupling of amino acids according to standard peptide synthesis and following Fmoc analysis. Here membrane discs having a diameter of 3 mm or membrane squares having a side length of 1.05 mm are laid in a 384 MTP of the company Greiner or a 1536 MTP and fixed or welded with a hot metal needle. On the membrane areas, Fmoc-Alanine has been coupled according to standard synthesis protocols (Fields et al. 1990) and the loading of the membrane has been determined by Fmoc-analysis. The Fmoc protection group has been separated by 20% piperidine and the amount of the Fmoc-group has been determined photometrically (extinction coefficient: 7800 M⁻¹cm⁻¹). For the membrane area in the 284 MTP an average load of 52 nmol has been determined. The calculated material amount was 57 nmol. For the membrane area in a 1536 MTP an average of 8.5 nmol has been determined at a calculated amount of 8.6 nmol.

### Example 2

### Removing of Reagent Remainders

During washing cycles, membrane areas soaked with reagent solutions (fluorescine) are washed. A membrane with a diameter of 0.3 mm has been fixed in 8 wells of a 384 PP-MTP of the company Greiner Bio-one (Frickenhausen) and loaded with 3 μl of a 0.1 mg/ml fluorescine solution (=220 nmol, 0.073 mol/l) and the fluorescence (50 ms, 560 nm) has been determined by means of a LUMI-Imager® of the company Roche Diagnostics GmbH, Mannheim. Then, it was washed by means of a Embla 384 Plate Washer of the company Molecular Devices (Ismaningen) with ethanol (+0.1% TFA) and then the fluorescence was immediately measured again in the LUMI-Imager. The following washing program has been used:

20 μl of the solution were filled in;

waiting time 10 s

suction (2 mm/s advance, 2 s waiting time)

After at most 4 of such washing cycles no difference to the non-treated membranes could be detected as shown in FIG. 3.

1. A synthesis apparatus with a substrate having at least one cavity as well as a solid phase support arranged in the cavity, the solid phase support being fixed with at least a relatively small area section as compared to its total area to a corresponding partial section of the cavity.

2. The synthesis apparatus according to claim 1, wherein the substrate is a microtiterplate and the cavities correspond to the wells provided in the microtiterplate.

3. The synthesis apparatus according to claim 1 or 2, wherein the cavity comprises at least one wall section and one bottom section.

4. The synthesis apparatus according to claim 3, wherein the solid phase support is fixed to the bottom section and/or the wall section of the cavity.

5. The synthesis apparatus according to any one of claims 1 to 4, wherein the solid phase support is fixed by the effects of thermal energy to at least one partial section of the cavity.

6. The synthesis apparatus according to claim 5, wherein the solid phase support is fixed with at least one welding point per cavity to the substrate.

7. The synthesis apparatus according to any one of claims 1 to 6, wherein the solid phase support is a chemically functionalized membrane.

8. The synthesis apparatus according to any one of claims 1 to 7, wherein the substrate has thermoplastic properties.

9. The synthesis apparatus according to any one of claims 1 to 7, wherein both the substrate and the solid phase support have thermoplastic properties.

10. The synthesis apparatus according to any one of claims 1 to 9, wherein the solid phase body is chosen from the group comprising a teflon membrane, cellulose, polypropylene.

11. The synthesis apparatus according to any one of claims 1 to 10, wherein the substrate is made of polypropylene.

12. The synthesis apparatus according to any one of claims 1 to 11, wherein the form of the solid phase support is essentially the form of the cavity with regard to its bottom area.

13. The synthesis apparatus according to any one of claims 3 to 12, wherein the solid phase support is formed in such a manner that it hardly has contact to the wall section of the cavity.

14. A method of manufacturing a synthesis apparatus, especially according to any one of claims 1 to 13 comprising the steps of:
a) providing a substrate with at least one cavity;
b) introducing a solid phase support into the cavity; and
c) fixing the solid phase support in the cavity by bonding a relatively small area section as compared to its total area to a corresponding partial section of the cavity.

15. The method according to claim 14, wherein the fixing according to step c) is effected by the influence of thermal energy.

16. The method according to claim 15, wherein the fixing according to step c) is effected by point welding.

17. The method according to any one of claims 14 to 16, wherein the solid phase support is fixed per cavity at one single point.

18. The method according to any one of claims 14 to 18, wherein the introduction according to step b) is effected by stamping the solid phase support out of a sheet, wherein the stamped out solid phase support falls into the cavity.

19. The method according to any one of claims 14 to 18, wherein the form of the solid phase support corresponds essentially to the form of the cavity with regard to its bottom area.

20. The method according to any one of claims 14 to 19, wherein the solid phase support is formed in such a manner that it is introducible into the cavity without contact to the wall.

21. The method according to any one of claims 14 to 20, wherein the before introducing the solid phase support according to step b) the cavity is wetted at least in its wall area with a fluid.

22. The method according to any one of claims 15 to 21, wherein fixing according to step c) is effected by pressing the solid phase support with at least one metal point heated to about 450° C. and having a diameter of about 0.3 mm for about 0.8 s on the cavity.

23. The method according to any one of claims 14 to 22, wherein by during fixing according to step c) vitrification of the bonding area occurs.

24. A use of the synthesis apparatus according to any one of claims 1 to 13 or the method according to any one of claims 14 to 23,in the combinatorial chemistry especially in the solid phase synthesis.
